(19) United States
(12) Patent Application Publication
(10) Pub. No.: US 2016/0355045 A1
(43) Pub. Date: Dec. 8, 2016

(54) SECURITY BOOKLET

(71) Applicant: D.A. Offray & Son, Inc., Wilmington, DE (US)

(72) Inventors: James Mark Ivester, Davidson, NC (US); Sterling R. Mensch, III, Greer, SC (US)

(73) Assignee: D.A. Offray & Son, Inc., Wilmington, DE (US)

(21) Appl. No.: 14/730,402

(22) Filed: Jun. 4, 2015

(51) Int. Cl. B42D 25/40; B42D 25/24

(52) U.S. Cl. CPC B42D 25/40; B42D 25/24

(57) ABSTRACT

A security booklet is provided having a data page with personal data and security features. The data page is bonded to one side of a band of fabric constructed of sheath and core fibers incorporating a taggant. The opposite side of the band of fabric is fastened within the booklet creating a hinge for the data page.

The present invention is directed to a security booklet, such as a passport, provided with a tamper resistant data page bound in the booklet with a flexible band of textile fabric. The band of fabric incorporates a multicomponent fiber.

### BACKGROUND OF THE INVENTION

Security booklets, such as passports, typically comprise a cover and various pages bound together. The pages include a personal data page, which may include a person's photograph and date of birth, the document number, e.g. passport number, place and date of issue, etc. The booklets are provided with various security features to prevent forgery.

Data pages incorporating one or more polycarbonate sheets have been introduced to support various security features in documents. Polycarbonate is durable and highly transparent to visible light. Furthermore, polycarbonate sheets are compatible with various Level 1 (overt), Level 2 (covert) and Level 3 (forensic) security features, including laser engraving.

The data page may be bound in a security booklet by a band of flexible material. For example, the inside edge of the data page may be bonded to one side of the band, and the opposite side of the band may be sewn into the booklet, thereby forming a resilient hinge for the data page. In order to thwart forgery by replacement or alteration of the data page, it is critical to ensure that the data page and the band are difficult to separate and that any attempt to separate the two components be detectable.

Various methods and structures for connecting a data page to a flexible band of material, for use in a security booklet are disclosed in the following references.

Wesselink, U.S. Pat. No. 6,213,702 B1 discloses connecting a data page (plate) to a flexible band and affixing the band in a security booklet. The band is provided with apertures along the edge of the band connected to the plate, and the band is sandwiched between the plate and a strip of material having projections that extend through the apertures in the band.

Iliescu et al., U.S. Pat. No. 7,040,981 B2 disclose a flexible band having apertures, which is laminated between hard “core” layers of the data page to produce bonds between the adjacent core layers.

Beyer-Meklenburg et al., U.S. Pat. No. 7,758,079 B2 disclose a multilayer data page having a projecting textile layer, such as a polyester textile fabric. The projecting textile layer may be sewn into a security booklet.

Christen et al., U.S. Pat. No. 8,336,915 B2 and U.S. Pat. No. 8,585,093 B2 disclose employing a textile fabric having apertures, such as a woven polyester fabric having mesh openings, as the flexible band for connecting a data page in a security booklet. The data page is provided with thermoplastic sheets, and the band is laminated between the sheets of the data page. The thermoplastic sheets form “weld points” at the site of the apertures in the textile fabric band.

Elgi et al., US Publication No. 2011/0091677 A1 disclose a data sheet for a security booklet having a flexible band as the connecting element. The area of attachment between the data sheet and the connecting element has a “weakened portion”, which makes it more difficult to separate the data sheet and the connecting element without detectable damage.

Security articles comprising fibers having complex cross sections, multi-components, and taggants are disclosed in the following references: Tam et al., U.S. Pat. No. 7,122,248 B2; Lee et al., US Publication No. 2005/0112610 A1; Dugan, US Publication No. 2005/0227068 A1; and Merchant et al., U.S. Pat. No. 8,137,811 B2. In a typical application, staple fibers incorporating such security features are incorporated in a sheet, such as paper currency.

Despite the prior art efforts, there remains a need for security booklets having improved security measures to prevent and detect forgery.

### SUMMARY OF THE INVENTION

A security booklet is provided having a plurality sheets, one of which is a data page. Optionally, the security booklet is provided with a cover. The data page includes identifying information, such as a person's photograph, date of birth, issued identification numbers, such as a passport number or visa number, biometric data, etc., referred to generally herein as personal data.

The data page includes at least one sheet of a synthetic polymer material. By way of example, the polymer may be a thermoplastic or thermosetting polymer, or combinations thereof. Particularly useful are transparent thermoplastic polymers, such as polycarbonate.

The data page may include additional layers of the same or different materials laminated together. In one embodiment of the invention, the data page includes a polymer sheet laminated to a substrate. The substrate may contain multiple layers of different materials. Additionally, a second polymer sheet may be laminated to an opposite side of the substrate from a first polymer sheet to create three or more layers. Alternatively, the second polymer sheet may be laminated directly to the first polymer sheet. The composition of the first and second sheets may be the same or different. The data page may incorporate various security features, including Level 1, Level 2 and Level 3 security features, in one or more of the layers.

The polymer sheet(s) extends outward along an inside edge of the data page, providing a surface area to be bonded to a band of textile fabric. The textile fabric may be a woven, knitted, or non-woven structure. The textile fabric incorporates multicomponent fibers comprised of at least two different polymeric materials, extending along the length of the fiber. In one embodiment of the invention, the multicomponent fiber is a sheath and core, bicomponent fiber. Of particular interest, are sheath and core fibers wherein the sheath component is polycarbonate. By way of example, the core of the fiber may be a polymer having a relatively higher melting temperature, as compared to the sheath component, such as polyethylene terephthalate or nylon. In one embodiment of the invention, the band is a woven textile fabric incorporating monofilament multicomponent fibers.

One or more of the components of the multicomponent fiber of the textile fabric may be provided with a taggant. For example, each of two components of the multicomponent fiber may be provided with a different taggant. Of particular interest are sheath and core bicomponent fibers having a taggant in the sheath component or a taggant in the core component, or different taggants in each of the sheath and core. The band of textile fabric may have various security features applied thereto, for example, by printing with an ink, which optionally may contain a taggant, such as personal data, e.g. a passport number; symbols; barcodes, etc. In the case of a sheath and core fiber construction, security features applied to the surface of the textile fabric will mark the sheath component of the fibers.

The area of the polymer sheet(s) extending along the edge of the data page is bonded to one side of the band of textile fabric, and the opposite side of the band is fastened to the booklet to create a hinge for the data page. The polymer and band may be bonded together by any of a variety of plastic welding techniques known to those skilled in the art, or by chemical bond, such as direct covalent bond between the structures or via a cross-linking agent or adhesive at the interface between the structures. Of particular interest, are bonding systems that directly fuse the polymer sheet of the data page and the band, over at least a portion of the area of overlap of the structures.

Prior to bonding the data page to the band of textile fabric, the section of the polymer sheet that is bonded to the band may be marked on the surface with personal data or other security feature. It is also possible to transfer such security features from the polymer sheet of the data page to the surface of the band during the bonding process. For example, an ink or other marker can be selected that will adhere to or at least partially diffuse into the outer surface of the fibers comprising the band of textile fabric.

The present invention is particularly useful for developing security features that prevent or detect forgeries related to the attachment, detachment or reattachment of a data page to the security booklet. For example, security features can be provided that will be damaged and difficult to repair without being detectable, if attempts are made to separate the data page from the security booklet. Additionally, personal data and other unique indicators can be incorporated into the data page and the band of the security booklet, which are difficult to obliterate without creating detectable damage.

In a broad sense, the invention is directed to a security booklet having a data page with a polymer sheet and a band for attaching the data page to the booklet, whereby the band incorporates a multicomponent fiber selected to enhance the security features of the booklet. In particular, the combination of the polymer sheet of the data page bonded to the band of textile fabric incorporating a multicomponent fiber may be tailored to enhance security capabilities in one or more of the following ways.

The difficulty of separating the data page and the band may be increased by providing a component of the surface of the multicomponent fiber that forms a strong bond with the polymer sheet of the data page. The difficulty of separating the data page and the band may be increased by providing a component of the multicomponent fiber that has a relatively high tensile strength. The difficulty may be synergistically increased by providing a sheath and core multicomponent fiber having a sheath that forms a strong bond with the polymer sheet and a core that has a high tensile strength relative to the sheath. The difficulty of separating the data page and the band may be increased by providing multicomponent fiber in the band, whereby (i) the component of the fiber bonded to the band has substantially the same melting temperature as the polymer sheet, such that the polymer sheet and component of the fiber cannot be cleanly separated by heating; or (ii) the component of the fiber bonded to the band has substantially the same solvent solubility as the polymer sheet, such that the polymer sheet and component of the fiber cannot be cleanly separated by dissolution of one or the other of the structures.

The security features of the booklet may be enhanced by providing a multicomponent fiber having a component located on the surface of the fiber with substantially the same refractive index as the polymer sheet, making the interface between the multicomponent fiber, especially a sheath and core fiber, and the polymer sheet more difficult to discern.

The multicomponent fiber may be provided with a component on the surface of the fiber, especially a sheath and core fiber, that can be bonded to the polymer sheet by melt mixing at the interface between such component and the polymer sheet. The phenomenon of intermolecular diffusion at the interface during melt mixing may be employed to transfer markers such as inks and taggants between the multicomponent fiber and the polymer sheet, thereby providing a means to detect forgery. The component of the multicomponent fiber bonded to the polymer sheet and the polymer sheet can be selected to be miscible at the bonding temperature.

Sheath and core multicomponent fibers are particularly useful in enhancing the security features of a security booklet. Attempts to separate the data page and the band may be detectable by separation of the sheath from the core, which may be detected by gaps in the sheath or portions of the core revealed, either or both of which may be amplified by the use of appropriate taggants.

The present invention may include one or more of the following features and combinations thereof: the polymer sheet is transparent and at least one of the components of the multicomponent fibers in the band of textile fabric is transparent; the multicomponent fiber is a sheath and core, bicomponent fiber and the sheath is transparent; the polymer sheet and the sheath component of the multicomponent fiber are substantially the same material; the refractive index of the polymer sheet and the refractive index of the sheath component of the multicomponent fiber are substantially the same; one component of the multicomponent fiber is an amorphous polymer and one component is a semi-crystalline polymer; and the polymer sheet and the sheath component of the sheath and core multicomponent fiber have a melt processing temperature within 50° C., in particular, within 25° C. of each other.

### BRIEF DESCRIPTION OF THE DRAWINGS

FIG. 1 is a perspective view of the security booklet in an open position showing the data page.

FIG. 2 is a side view of a data page with a single polymer sheet bonded to a band.

FIG. 3 is a side view of a data page with a substrate positioned between first and second polymer sheets bonded to a band.

FIG. 4 is a side view of a data sheet with first and second polymer sheets bonded to a band, with the band extending substantially to the outside edge of the data sheet.

FIG. 5 is a side view of a data sheet with a substrate positioned between first and second polymer sheets bonded to a band, with the band extending substantially to the outside edge of the data sheet.

FIG. 6 is a perspective view of the textile fabric band.

FIG. 7 is a magnified view of the construction of the textile fabric band.

FIG. 8 is a perspective view showing the cross section of a multicomponent fiber incorporated into the band.

FIG. 9 is a section view of the textile fabric band of FIG. 6.

FIG. 10 is a section view of the textile fabric band of FIG. 9 following heat-setting to minimize interstices in the fabric.

FIG. 11 is a perspective view of the textile fabric band having personal data and generic security features applied thereto.

FIG. 12 is a magnified view of a security feature of the band of FIG. 11.

FIG. 13 is a perspective view of the data page and the band prior to bonding.

FIG. 14 is a top view of the assembled data page and band.

FIG. 15 is a section view of the area where the data page and band are bonded, showing a laser engraved image.

FIG. 16 is a perspective view of a security booklet being analyzed for forgery.

FIG. 17 is a magnified view of the security booklet of FIG. 16, showing detectable damage to the multicomponent fibers in the band.

FIG. 18 is a perspective view of the data page and the band, wherein the portion of the band bonded to the data page has different physical properties, than the portion of the band fastened to the booklet.

### DETAILED DESCRIPTION OF THE INVENTION

Without intending to limit the scope of the invention, the preferred embodiments and features are hereinafter set forth. Unless otherwise indicated, conditions are 25° C., 1 atmosphere of pressure and 50% relative humidity, concentrations are by weight, and molecular weight is based on weight average molecular weight. The term “polymer” or “polymeric material” as used in the present application denotes a material having a weight average molecular weight (Mw) of at least 5,000. Such polymeric materials can be amorphous, crystalline, or semi-crystalline materials, including elastomeric polymeric materials.

All of the United States patents cited in the specification are incorporated herein by reference.

Unless defined otherwise, all technical and scientific terms used herein have the same meaning as commonly understood by one of ordinary skill in the art to which the invention pertains. In describing and claiming the present invention, the following terminology is used in accordance with the definitions set out below.

A “taggant” is a detectable physical, chemical or biological marker added to materials to enable identification of the material or an article or composition with which the material is associated. By way of example, the taggant may be a colorant detectable by UV, visible or IR electromagnetic radiation or combinations thereof; a colorant or image exhibiting metamerism; a particle having a complex geometry, crystalline structure, or combination of materials, such as multi-layers of different materials; a fiber having a complex geometry or combination of different materials; biological markers, such as DNA and endospores, which may be genetically modified. No particular size is implied, and the taggant may be a molecule, nanoparticle, nanocrystal or larger particle. The taggant may be an inorganic or organic material. The taggant may be identifiable by an isotope or ratio of constituents. The taggants useful in the present invention are not intended to be limited to a particular means of detection. By way of example, the taggant may provide an overt, covert or forensic level of security and be detectable by optical, magnetic, electromagnetic, spectroscopic or radioactive characteristic.

“Multicomponent Fibers” are fibers having at least two distinct cross sectional domains of different components. Multicomponent fibers useful in the present invention can be manufactured by co-extrusion of the two or more polymer components, or by a secondary application of a polymer to a preformed core.

“Polycarbonates” are polymer containing the carbonate groups (—C—(C═O)—O—). Polycarbonates are typically synthesized by reacting phosgene and an aromatic or aliphatic diol. Of particular interest are polycarbonates having bisphenol A (BPA) or dimethyl bisphenol cyclohexane, or combinations thereof in the backbone. Additionally, the polycarbonates useful in the present invention may be a polycarbonate graft copolymer, such as disclosed in U.S. Pat. No. 8,426,532 B2.

A “sheet” is a planar material, that is, thin in comparison to its length and breadth. The term “sheet” is not intended to be limited to a particular range of thickness and is intended to include films.

“Light transmittance” is total transmittance as measured by ASTM D1003-13.

The “melt processing temperature” of semi-crystalline and crystalline polymers is the Tₘ determined by differential scanning calorimeter (“DSC”) according to ASTM D3418-12e1, with Tₘ reported as the top of the melting transition peak; and for amorphous polymers, e.g. those having no significant first order transition, is the T_{g} determined by DSC according to ASTM D3418-12e1, with T_{g} reported as the midpoint of the observed second order transition.

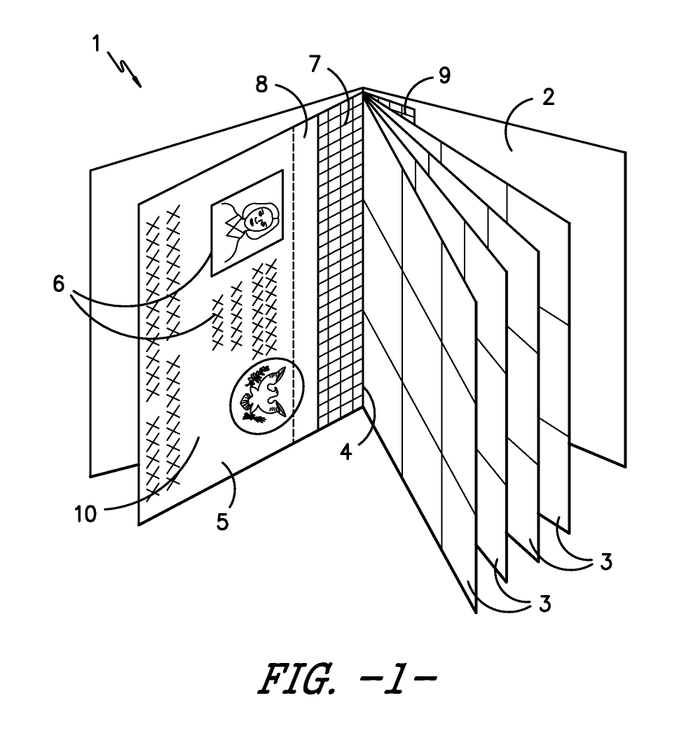

Referring to FIG. 1, booklet 1 has cover 2 and pages 3 bound together along hinge 4. One of pages 3 is data page 5, which includes personal data 6, such as a photograph of an individual, date of birth, document number, e.g. passport number. Data page 5 is bonded to band 7 along the inner edge 8 of data page 5. The portion of band 7 extending inward from data page 5 is bound into booklet 1 along hinge 4. By way of example, band 7 may be bound into booklet 1 by sewing, such as with a security yarn, adhesive, such a hot melt adhesive, mechanical fastening, such as rivets, or other method employed to bind pages, to prevent their removal from a booklet. An outer edge 9 of band 7 may extend beyond hinge 4.

Booklet 1 may be a passport, visa, identification card, ticket, pass, badge or credentials, such as maritime, government, military or corporate documents.

Referring to FIGS. 1-5, data page 5 includes at least polymer sheet 10. Sheet 10 may be a thermoplastic or thermoset polymer, or combinations thereof. Of particular interested are thermoplastic polymer compositions that are transparent, that is, a polymer composition having light transmittance of 80% or more, in particular 85% or more, and polymers that are laser engraveable. By way of example, polymer sheet 10 may be polycarbonate (PC), polyolefin, for example polypropylene (PP), and including polyolefins containing a nucleating agent to improve clarity, glycol modified polyethylene terephthalate (PETG), polymethylpentene (PMP), poly (methyl methacrylate) (PMMA), polystyrene (PS), styrene methyl methacrylate polymer (SMMA), or styrene acrylonitrile polymer (SAN). Polycarbonate is particularly useful for polymer sheet 10.

Various configurations of the data page are possible within the scope of the present invention. Referring to FIG. 2, data page 5 is bonded to band 7, along the inside edge 8 of sheet 10.

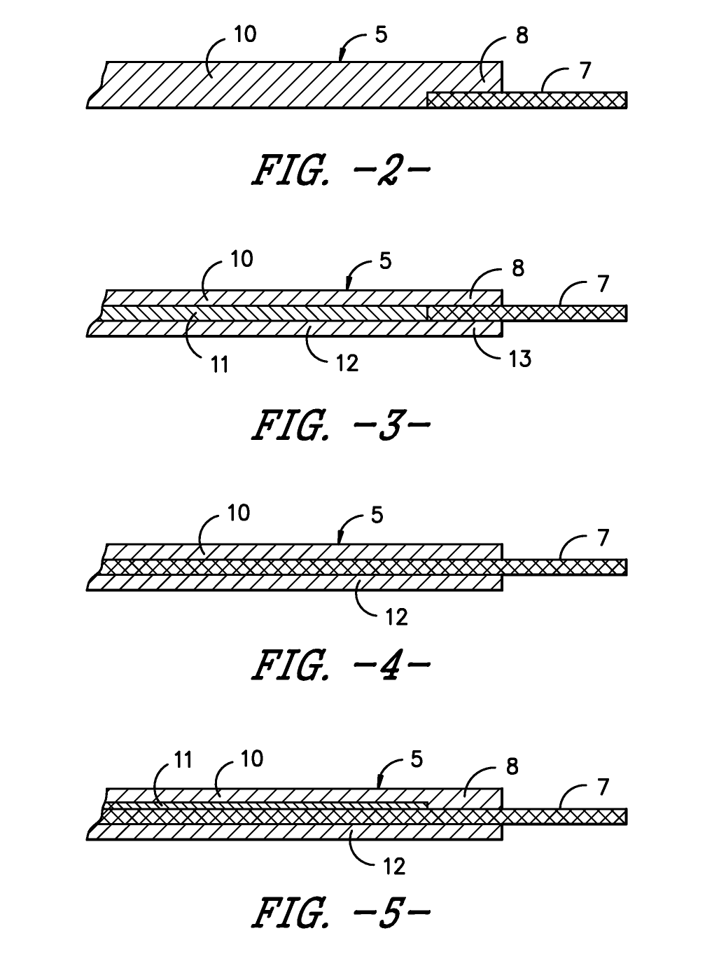

Referring to FIG. 3, data page 5 includes substrate 11 positioned between sheet 10 and sheet 12. By way of example, sheet 12 may be a polymer, which is the same or different than sheet 10. In one embodiment of the invention, both sheet 10 and sheet 12 are polycarbonate. Substrate 11 may be a flexible sheet of, for example, a natural or synthetic cellulosic based material or a thermoplastic or thermoset polymer material. In the example illustrated in FIG. 3, inner edge 8 of sheet 10 and inner edge 13 of sheet 12 are bonded to band 7.

Referring to FIG. 4, data page 5 includes sheet 10 and sheet 12 having the features identified above. Instead of band 7 being bonded along the inner edge of data page 5 only, band 7 extends substantially all of the way across data page 5 and is bonded between sheets 10 and sheet 12 over a broader area.

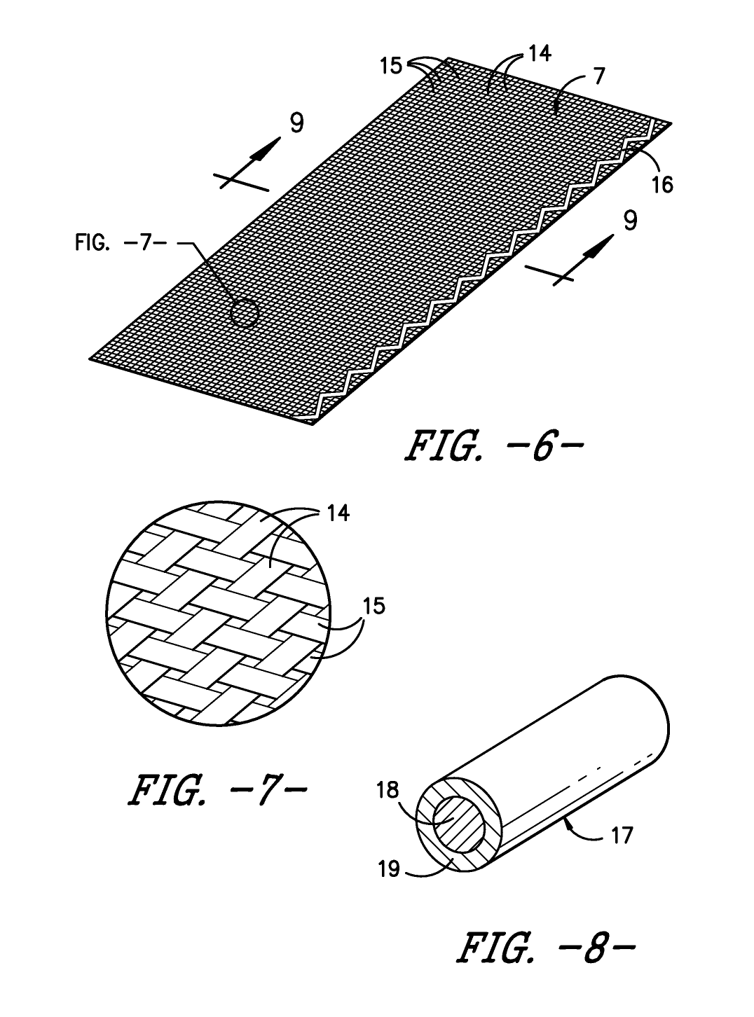

Referring to FIG. 5, data page 5 includes sheet 10, substrate 11, band 7 and sheet 12. Sheet 10 is bonded to band 7 along inner edge 8, whereas sheet 12 is bonded to band 7 substantially along the full area of data page 5.

It can be understood that the laminate structures illustrated in FIGS. 2-5 may include additional layers of material incorporated within data page 5. For example, while substrate 11 is shown as a single layer of material, substrate 11 may comprise multiple layers of the same or different materials. Additionally, data page 5 may include one or more security devices incorporated within the laminate structure, such as an RFID chip. Furthermore, either or both of the polymer sheets of the data page may be constructed of multiple layers. For example, each of multiple sheets may be separately laser engraved or cut to create a holographic image when assembled.

The bond between the data page 5 and band 7 may be formed by plastic welding. For example, heat is generated at the welding interface, to create intermolecular diffusion from the polymer sheet to the band, that is, melt mixing at the interface. Heat may be generated by external or internal heating methods. In one embodiment of the invention, the polymer sheet and band are heated to a temperature above the melt processing temperature of each of the polymer sheet and the band, such that melt mixing occurs at the interface between the polymer sheet and at least one component on the surface of the multicomponent fibers incorporated in the band. Pressure may be applied during the heating stage to improve melt flow across the interface and maintain orientation of the data page and band.

The data page may incorporate one or more security features. By way of example, the security feature may be a taggant incorporated into one or more components of the data page. Also within the scope of the invention is the use of a first taggant in one polymer sheet of the data page and a second taggant in a second polymer sheet of the data page, with both of the polymer sheets being bonded to the band, as exemplified in FIGS. 3-5. In one embodiment of the invention, one or both of the polymer sheets bonded to the band has a material dispersed across the depth (thickness) of the sheet or structure incorporated therein that will be damaged if the sheet is sliced, shaved or has a layer removed, such as security threads, particles having a high aspect ratio of length to width, multiple-layer laser engraved images, such as a holographic image, etc.

Further examples of security features that may be employed with the data page are an RFID chip containing personal or biometric data, laser engraving, including changeable laser images and multiple laser images, embossing, braille characters, security printing and specialty inks, optical variable devices, watermarks and ghost images, microprinting, machine readable data, including bar codes, tamper-evident die cuts, magnetic strips or other electronic data storage media, etc.

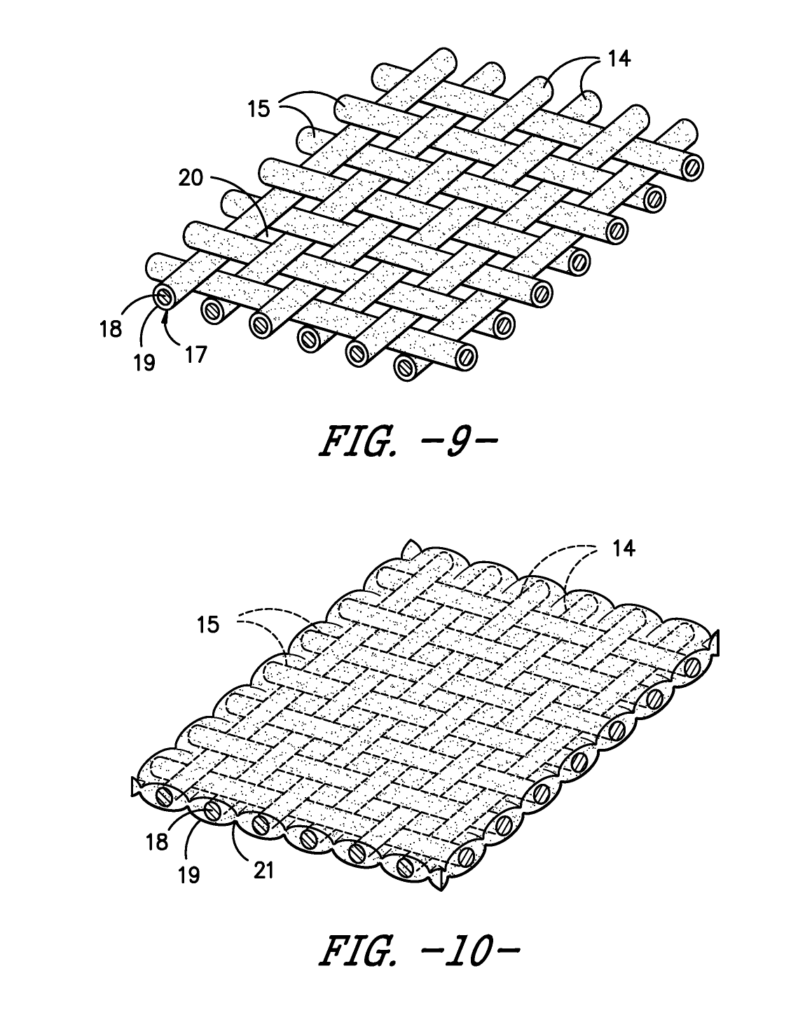

The band of material for attaching the data page to the security booklet is a textile fabric. The textile fabric may be a woven, knitted, or non-woven structure. Referring to FIG. 6, band 7 is a woven textile fabric constructed of warp yarns 14 and weft (or fill) yarns 15. An enlarged view of band 7 is shown in FIG. 7. Band 7 may be provided with embossed edge 16, which seals the edge of the fabric, acts as a security device that will indicate tampering with the binding of the band in the booklet, and provides lateral stability to the fabric. Band 7 may be embossed by heat, including ultrasonic heating, heat and pressure, such as by calendaring with a heated roller, chemical treatment, or other technique known to those skilled in the art. The edges of band 7 may be die, laser or ultrasonically cut to minimize fraying.

The textile fabric incorporates multicomponent fibers comprised of at least two different polymeric materials. A first components of the multicomponent fiber may be selected to provide high tensile strength and resilience. A second component of the multicomponent fiber may be selected to provide a strong bond with one or both of the polymer sheets of the data page, especially by plastic welding. Also within the scope of the invention is to select the second component of the multicomponent fiber to have one or more characteristics, such as glass transition temperature, softening temperature, flow temperature, melting temperature, solvent solubility, miscibility at the melt processingg temperature, and refractive index, relative to the characteristics of a polymer sheet(s) of the data page, whereby separation of the data page and the band is made more difficult and easier to detect.

The multicomponent fiber may be a side-by-side, sheath and core, or other segmented structure. No particular limitation on the cross section of the multicomponent fiber is required and the cross section may be round, oval, flat, rectangular, trilobal, etc. Generally, at least 35%, in particular at least 50%, of the surface area of the fiber contains the second component of the multicomponent fiber. Of particular utility are sheath and core multicomponent fibers. Referring to FIG. 8, fiber 17 is a sheath and core bicomponent fiber shown in cross section, having core 18 and sheath 19. The multicomponent fiber may be made by co-extruding the multiple components, or by first extruding the first component and incorporating additional components in subsequent processing steps, such as by extruding or dip coating.

Sheath 19 may be selected based on the characteristics of forming a high bond strength with the data page, and being difficult to separate by physical and chemical means. In various embodiments of the invention, both the polymer sheet of the data page and the sheath component of the multicomponent fiber are amorphous polymers, with the sheath having a melt processing temperature that is within 50° C., in particular, within 25° C., of the melt processing temperature of the polymer sheet of the data page, to facilitate bonding the structures without causing distortion or damage to any security features incorporated in the data page, such as laser engraved images.

Various advantages can be realized when the refractive indices of the polymer sheet(s) of the data page and the sheath of the multicomponent fiber are substantially the same. For example, the lack of a visual transition between the polymer sheet and the multicomponent fiber thwarts forgery by making it more difficult to separate the structures. Also, less visual distortion is created at the interface between the structures when the security features incorporated in the data page and the band are examined. In one embodiment of the invention, the refractive indices of the polymer sheet and sheath component differ by 0.05% or less, in particular by 0.02% or less.

By way of example, the second component of the multicomponent fiber, e.g. the sheath component of a sheath and core multicomponent fiber, may be polycarbonate (PC), polyolefin, for example polypropylene (PP), and including polyolefins containing a nucleating agent to improve clarity, glycol modified polyethylene terephthalate (PETG), polymethylpentene (PMP), poly (methyl methacrylate) (PMMA), polystyrene (PS), styrene methyl methacrylate polymer (SMMA), or styrene acrylonitrile polymer (SAN), thermoplastic polyurethane (TPU), polyester, such as polyethylene terephthatlate, or polyamide, such as nylon. Of particular interest, are sheath and core fibers wherein the sheath component has substantially the same composition as the polymer sheet of the data page. For example, if one or both of the polymer sheet of the data page are polycarbonate, the sheath of the fibers is also polycarbonate.

By way of example, the first component of the fiber may be a polyester, such as poly(ethylene terephthalate) (PET), poly(butylene terephthalate) (PBT), a polyolefin, such as polyethylene, polypropylene polybutene, and polymethyl pentene (PMP) and olefin copolymers, a polyamide, such as a nylon, or a polyurethane, such as thermoplastic polyurethanes. Other polymers of interest for the core of the multicomponent fiber include acrylics and polyacrylates, polystyrenes, polyvinyl alcohol, polyethylene naphthalate, polytrimethylene terephthalate, poly(1,4-cyclohexylene dimethylene terephthalate) (PCT), and aliphatic polyesters such as polylactic acid (PLA), polyphenylene sulfide (PPS), thermoplastic elastomers, polyacrylonitrile, cellulose derivatives, fluoropolymers, such as poly(tetrafluoroethylene), copolymers and terpolymers thereof and mixtures or blends thereof. In one embodiment of the invention, core 18 (measured by itself) has a tenacity of 2 grams per denier (gpd) or greater, in particular 4 gpd or greater, most particularly, 6 gpd or greater (at a pull rate of 12 inches/minute).

In one embodiment of the invention, the first component of the multicomponent fiber, for example, the core, is a semi-crystalline polymer and the second component of the multicomponent fiber, for example, the sheath, is an amorphous polymer. By way of example, the melt processing temperature of the first component may be 50° C. or greater, or even 75° C. or greater, than the melt processing temperature of the second component, which allows plastic welding of the sheath to the polymer sheet of the data page, without affecting the structural integrity of the core fiber, which may be drawn to partially orient the yarn and increase its tensile strength. In one embodiment of the invention, the first component of the multicomponent fiber is a semi-crystalline or crystalline polymer having a Tₘ of 200° C. or greater, in particular 225° C. or greater, most particularly, 250° C. or greater. Of particular interest are sheath and core multicomponent fibers having a polycarbonate sheath and a polyester core.

In one embodiment of the invention, sheath and core of the multicomponent fibers are selected to have strong affinity for each other, to increase the force required to separate the data page and the band. In another embodiment of the invention, the sheath and core of the multicomponent fibers are selected so that the sheath will separate from the core, if the data page and band are forced apart, thereby creating gaps in the sheath, which are readily detectable, especially if a taggant is provided in the sheath or the core or in both.

Also within the scope of the invention is to provide a combination of two types of sheath and core fibers in the same band of textile fabric. For example, a first type of sheath and core fiber may be tailored to have a high bond strength between the sheath and the core, and a second type of sheath and core fiber may be tailored to allow the sheath to separate from the core at a relatively lower force. By way of example, the two types of fibers may be distributed in the warp direction, the fill direction or both. In one embodiment of the invention, personal data, distinctive marks and the like may be applied to the fabric, where both types of fiber are present, thereby making it both more difficult to remove such marking and easier to detect attempts to separate the data page from the band.

Band 7 may be constructed from monofilament, multifilament or staple yarns, or combinations thereof. In one embodiment of the invention, all of the yarns forming the textile fabric are multicomponent yarns. It can be understood that a combination of multicomponent yarns and single component yarns may be combined in the textile fabric. Various combinations of multicomponent and single component yarns may advantageously be employed with certain fabric constructions, to maximize the exposure of the multicomponent yarns to the polymer sheet(s) of the data page. For example, a satin or twill weave can be employed to increase the exposure of the warp or fill yarns in the face of the fabric. By way of example, the weight % of multicomponent fibers in the band of textile fabric may range from 5% to 100%, in particular, from 20% to 100%, most particularly, from 35% to 100%. The yarns forming the textile fabric may range in denier from 25d to 220d, in particular from 35d to 70d.

The multicomponent fibers of the band of textile fabric may be provided with one or more taggants. A first taggant may be incorporated in one component of the multicomponent fiber. A second taggant may be incorporated in a second component of the multicomponent fiber. The first and second taggants may be different. In a multicomponent fiber having a sheath and core structure, it is particularly advantageous to incorporate a taggant in the sheath component, whereby damage to the sheath caused by separation of the data page from the band can be detected by gaps on the surface of the fiber where the core is exposed. It is believed that in view of the uniform and intricate structure that may be created with a multicomponent fiber, especially a sheath and core structure obtained by co-extruding multiple polymer components, it would be very difficult to repair or reconstruct the fiber, in the event of damage caused by forgery.

In one embodiment of the invention, the core may be provided with a taggant and the sheath may be provided with an additive to shield the taggant in the core from detection. If a portion of the sheath is removed, the taggant in the core will be readily detected. By way of example, the multicomponent fiber may have an opacifier in the sheath and a colorant in the core. In another embodiment of the invention, a UV absorber may be incorporated in the sheath and a colorant that fluoresces in UV light incorporated in the core. In particular the colorant may be selected to emit light in the visible region after absorbing light in the UV region. The UV absorber may be selected to absorb UV light in the spectrum of peak UV absorbance by the colorant. Suitable UV absorbers may be found in the Plastic Additives Handbook 6^{th} ed. Zweifel et al. (2009) ISBN-13: 978-1569904305.

Thus, it can be understood that an additive incorporated in the sheath to shield a taggant incorporated in the core can be tailored to absorb in the region of the electromagnetic spectrum used to detect the taggant. Particular advantages may be realized if the additive incorporated in the sheath does not significantly lower the light transmittance of the polymer in the sheath and the taggant incorporated in the core absorbs and emits light in the visible region of the spectrum. For example, a colorant incorporated in the core that emits light in the visible region after absorbing light in the visible region and that fluoresces in UV light is advantageous for providing both Level 1 and Level 2 security, when used in combination with a transparent sheath incorporating a UV absorber.

In an embodiment of the invention incorporating single component yarns in the textile fabric, some or all of the single component yarns may incorporate a taggant, which may be different from the taggant(s) incorporated into the multicomponent fiber.

In one embodiment of the invention, the band of textile fabric incorporates at least one taggant that requires forensic evaluation, such as a biological taggant incorporating genetically modified DNA.

Also within the scope of the present invention is to provide only a fraction of the yarns of band 7 with a taggant. For example, only the warp yarns or only the fill yarns of a woven fabric may incorporate a taggant. In certain circumstances, for example to avoid interference between a laser engraving incorporated in a polymer sheet layer of the data page, only the yarns in a narrow strip of band 7 that is in contact with polymer sheet 10 may be provided with a taggant.

After fabric formation, the textile fabric band may be subject to various treatments to stabilize the fabric, improve bond strength to the data page and provide enhanced or additional security features. For example, the fabric may be heat-set, pressed, calendared or embossed.

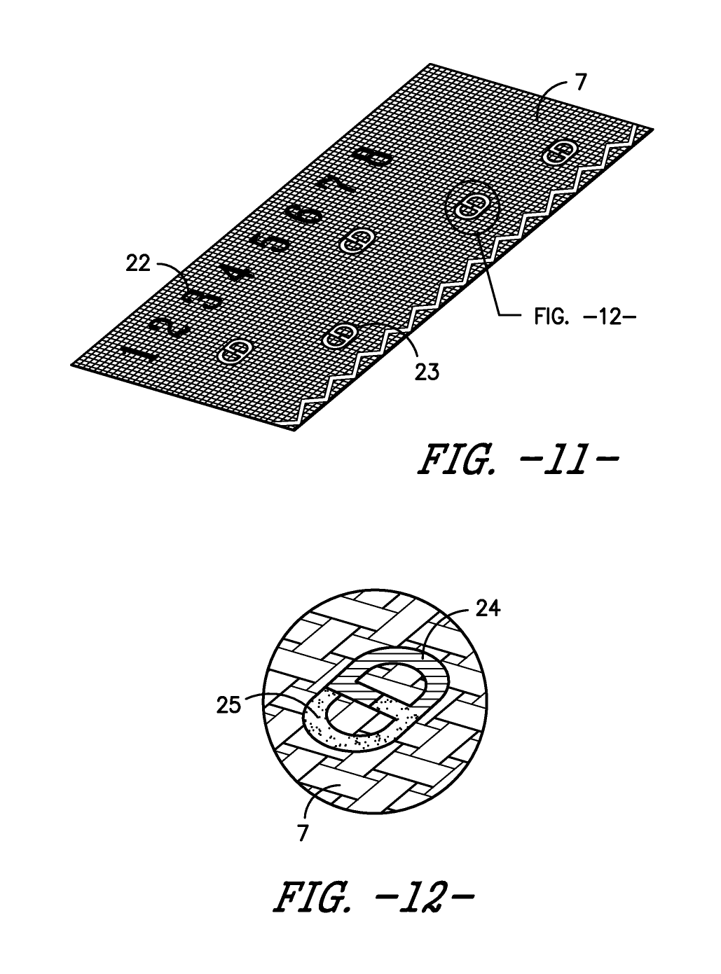

In one embodiment of the invention, the fabric is heat-set under pressure, for example by calendaring or belt press, to close or minimize the interstices in the fabric. Referring to FIG. 9, a plain weave fabric constructed of sheath and core bicomponent, monofilament fibers 17, having core 18 and sheath 19. Interstices 20 are present between warp yarns 14 and fill yarns 15. When the fabric is heat-set under pressure, the sheath component 19 of fibers 17 melts and flows into interstices 20 creating bridge elements 21, as shown in FIG. 10. By way of example the fabric may be heat set at a temperature of from 150 to 205° C., in particular from 160 to 195° C., and at a pressure of from 60 to 120 psi, in particular from 70 to 100 psi.

In an alternative embodiment of the invention, the interstices of the fabric may be filled with a polymer coating applied to the fabric after fabric formation. For example, a polymer in the form of a particulate, such as a powder, may be applied to the fabric in sufficient quantity to fill the interstices when the fabric is subsequently heat-set. The powder may be applied by scatter coating. A doctor blade or vacuum may be used to remove excess particulate from at least a portion of the fibers on the outer surface of the fabric.

In another embodiment of the invention, a film coating may be applied to the surface on one or both sides of the band, prior to the band being laminated to the data page. The film coating may be applied as a solution, dispersion or emulsion, for example, by spraying, padding, dip coating, or kiss roller, as is known to those skilled in the art, followed by drying and curing. Alternatively, the film coating may be applied as a melt, for example, by die extrusion coating. Another method of coating the band with a polymer is by hot melt spray application. Yet another method of applying a polymer coating to the band is by laminating a preformed film to the textile fabric by heat and pressure.

The polymer coating may be provided with a taggant or shielding material, such as an opacifier or UV absorber. In another example, the polymer filling may contain a cross linking agent to increase the strength of the bond between the band, in particular the sheath component of the fiber, and the data page. The polymer filling the interstices of the fabric, e.g. powder coating or film coating, may be the same composition as the polymer forming the outer or sheath component of the fiber, e.g. both the sheath and the polymer filling the interstices may be polycarbonate. The polymer filling is believed to lock the multicomponent fibers in place, increase the strength and lateral stability of the fabric and aid in forgery detection.

An advantage of minimizing or filling the interstices in the fabric, whether by partially melting the outer component of the multicomponent fiber and calendaring the fabric or applying a coating to the fabric, is that when the band is bonded to the polymer sheet of the data page, there is less distortion of 3-dimensional engraved or embossed images that have been created in the polymer sheet of the data page, in the region where the data page and band are bonded together. Yet another advantage to minimizing or filling the interstices is that bond strength is believed to be improved by being able to bond over a greater surface area.

The polymer used to coat the multicomponent fiber may be miscible with at least one component of the fiber. In one embodiment, the multicomponent fiber is a sheath and core fiber having a polycarbonate sheath, and the polymer coating comprises polycarbonate.

By way of example, polymer coating add-on to the fabric may range from 12 to 70 grams/m², in particular from 25 to 55 grams/m².

Prior to assembly of the data page and the band, additional security features may be applied to the surface of the band, especially the side of the band that is to be bonded to the polymer sheet of the data page. For example, personal data, such as a passport number, may be applied to the band, such as by printing with an ink. The ink may contain a taggant. The ink may contain a binder that improves the adhesion to the surface of the fibers forming the fabric. Heat and pressure may be applied to the fabric, after the ink is applied, to cause the marker in the ink to diffuse into the multicomponent fiber or to cure the ink.

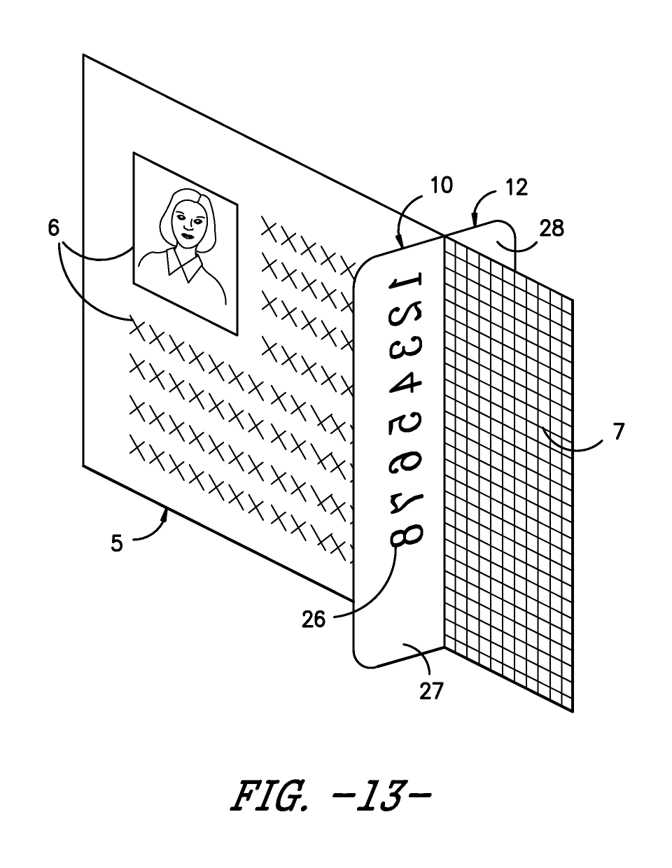

Referring to FIG. 11, band 7 has personal data in the form of an identification number 22 printed on the surface of the fabric prior to band 7 being bonded to the data page. The ink used to print the identification number may contain a colorant that is visible in ambient lighting and a taggant, for both Level 1 and Level 2 security. By way of example, a colorant that is red in the visible spectrum and which is fluorescent or phosphorescent in ultraviolet light may be employed. Identification number 22 is positioned along side 23 of band 7, which will be covered by the polymer sheet of the data page, when the band and data page are bonded together.

Another example of a security feature that may be printed on the surface of band 7 is symbol 23, which for illustration purposes is shaped like the Greek letter theta, but could have virtually any shape. A magnified view of symbol 23 is shown in FIG. 12. Symbol 23 has two parts—section 24 is printed in ink having a colorant visible under ambient conditions (Level 1 security) and section 25 is printed in ink containing a taggant, for example, a colorant visible only under UV light (Level 2 security).

The personal data and security features may be applied to the band of textile fabric either before or after a powder coating or film is optionally applied to the fabric. Personal data and security features may even be incorporated in a film laminated to band 7 prior to band 7 being bonded to data page 5.

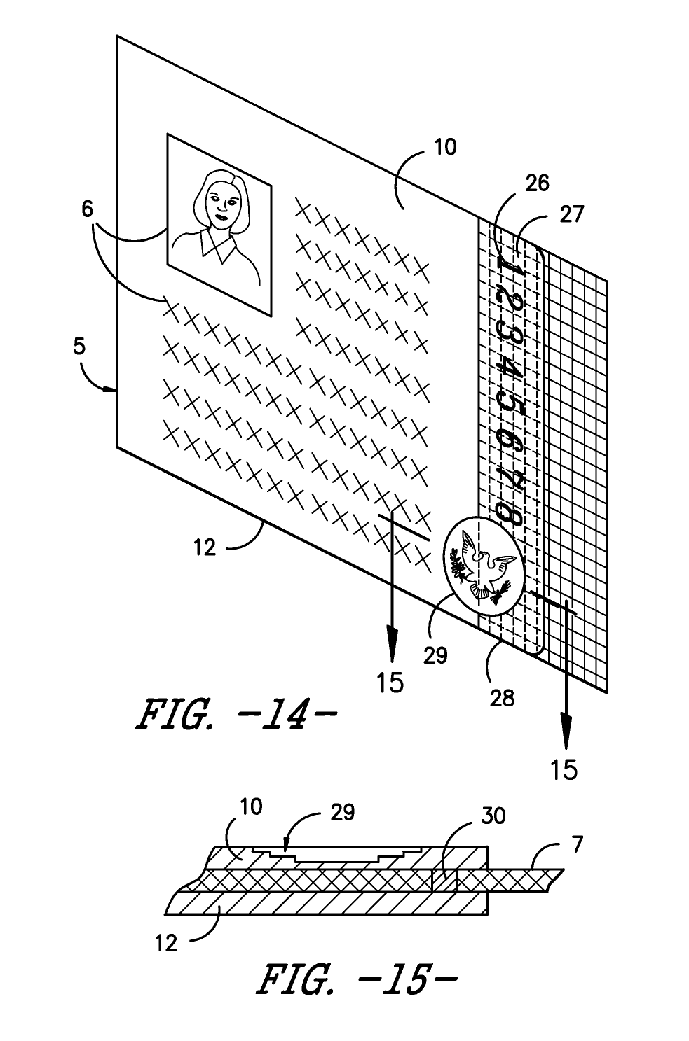

Referring to FIG. 13, an example of personal data in the form of identification number 26 has been printed on flap 27 forming the inside edge of polymer sheet 10. Flap 28 forms the inside edge of polymer 12. As shown in FIG. 14, band 7 is bonded between flaps 27 and 28 of polymer sheets 10 and 12, respectively. Identification number 26 can be printed on flap 27 in an ink formulated to transfer, adhere and/or diffuse into the fibers forming band 7, so even if polymer sheet 10 and band 7 are separated, for example, as part of a forgery, identification number 26 will be detectable on band 7. The ink used to print the identification number may contain a colorant that is visible in ambient lighting and a taggant, for both Level 1 and Level 2 security.

The polymer sheet(s) of the data page and the band of textile fabric may be bonded together under heat and pressure. By way of example, a polycarbonate polymer sheet and a band comprised of multicomponent fibers having a polycarbonate sheath and a polyethylene terephthalate core, the bonding may be accomplished at a temperature of from 170 to 210° C. for a period of from 5 to 30 seconds.

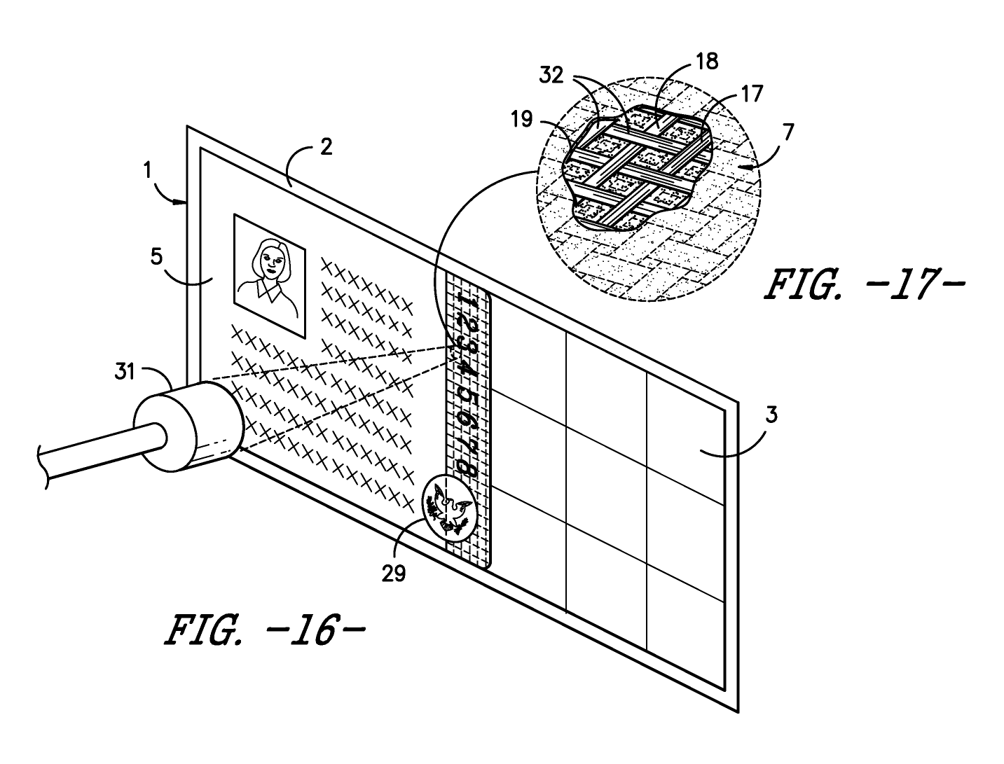

Referring to FIG. 15, a cross section of the area of the data page and band that is bonded together is shown. Laser engraving 29 overlays at least a portion of band 7 covered by flap 27 of sheet 10. A segment 30 of band 7 that is bonded to sheets 10 and 12 is provided with a taggant. For example, a section of multicomponent warp yarns in a woven fabric may be provided with a taggant. Segment 30 is positioned to the side of laser engraving 29, so that the taggant can be detected without interference from the laser engraving.

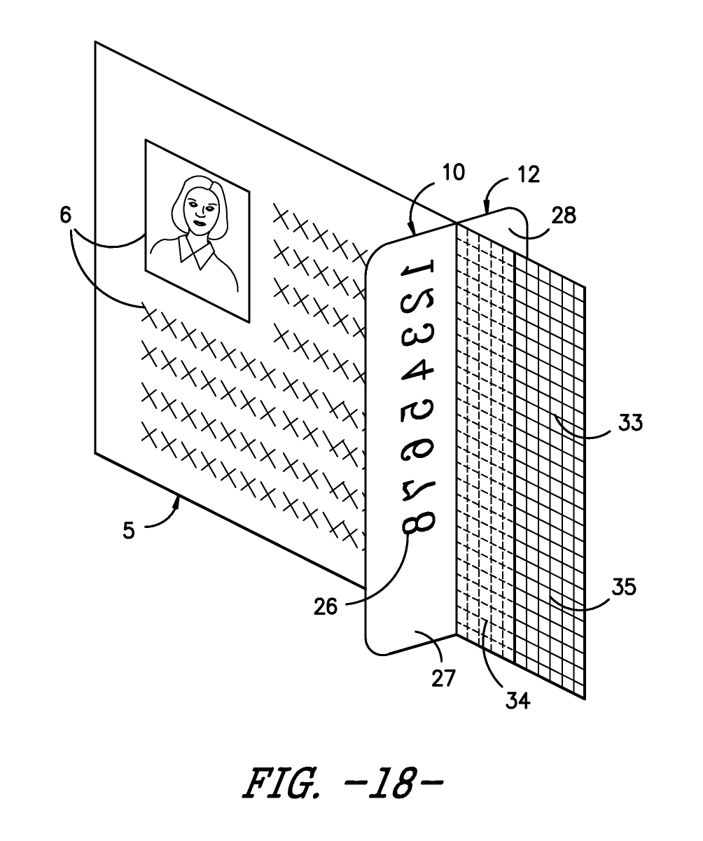

Referring to FIGS. 16 and 17, security booklet 1 is shown being examined under UV light source 31 capable of detecting a taggant incorporated into the sheath of a multicomponent fiber. It can be understood that the UV light source could be replaced by another detection method, depending on the specific taggant incorporated into band 7. For example, various detection methods are disclosed in U.S. Pat. No. 7,912,653 B1. A magnified view of the region of bonding between polymer sheet 10 and band 7 is shown in FIG. 17. Sections of fibers 17 where sheath 19 has been removed from core 18 are shown as voids 32.

Referring to FIG. 18, band 33 has a first lateral side 34, which is bonded to data page 5, for example along flaps 27 and 28, and band 33 has a second lateral side 35, opposite side 34, for fastening to the inside of a booklet. The side of the band that is bonded to the data page and the opposite side of the band that is bound in the booklet need not have identical physical and chemical properties. Moreover, advantages in performance may be achieved by providing a band with lateral sides having different physical or chemical properties.

The objective of providing lateral side 34 and lateral side 35 of band 33 with different properties is to enhance the respective functionalities of each side. In the case of lateral side 34, it is desirable to improve the bond strength between the fibers comprising band 33 and data page 5. It is believed that decreasing the air permeability of lateral side 34 increases the surface area for bonding and significantly improves bond strength. The decrease in air permeability, e.g. by closing or eliminating interstices in the fabric, may be accomplished by the various methods disclosed herein for finishing the fabric, including the application of heat, pressure, and polymer coatings, and combinations thereof.

Treatments of lateral side 34 to decrease air permeability and to improve bond strength have the general effect of increasing the stiffness of the fabric. If the fabric is overly stiff, however, then it does not function optimally as a hinge, where band 33 is fastened in a booklet.

Therefore, an object of this embodiment of the invention is to provide lateral side 35 of band 33 with relatively less stiffness than lateral side 34. The stiffness of band 33 has been found to be function of its permeability to air. As the interstices are closed or eliminated during finishing, the stiffness of the fabric increases. Thus, one method of providing lateral side 35 with relatively less stiffness and greater flexibility is to retain greater air permeability in the finished product. So, even if lateral side 35 is subjected to various methods disclosed herein for finishing the fabric, including the application of heat, pressure, and polymer coatings, and combinations thereof, for example to improve the lateral stability of side 35 and increase the force required to separate the data page from a booklet, lateral side 35 is less stiff, and will typically have greater air permeability than lateral side 34.

Methods of subjecting lateral side 34 and lateral side 35 of band 33 to different treatments to meet the aforementioned objectives are known to those skilled in the art. For example, after fabric formation, the fabric may be calendared on a roll having alternating sections or rings, whereby a first section applies relatively high heat and pressure to a width of the fabric corresponding to lateral side 34, and a second section of the calendaring roll applies relatively less heat and pressure to a width of the fabric corresponding to lateral side 35. It can be understood that depending on the width of the fabric prior to slitting, a calendaring roll having two, three, four, or more pairs of such sections may be employed.

In another embodiment of the invention, lateral side 34 and lateral side 35 of band 33 may have different constructions. For example, lateral side 34 may be provided with a higher fiber density, especially a higher fiber density of the multicomponent yarns. This can be accomplished by weaving the fabric with more ends per inch of the multicomponent fibers in lateral side 34, substituting multicomponent warp fibers in lateral side 35 with conventional, mono-component fibers, for example, with fibers having compositions identified as the “first component of the multicomponent fiber,” etc. Thus, even if the entire width of the fabric is finished under the same conditions, e.g. calendared under relatively high temperature and pressure, lateral side 35 will be less stiff than lateral side 34.

There are, of course, many alternative embodiments and modifications that are intended to be included within the following claims.

What we claim is:

1. A security booklet, comprising:
(a) a data page having a first polycarbonate sheet, wherein a section of the first polycarbonate sheet extends outward along an edge of the data page;
(b) a band of textile fabric incorporating a plurality of multicomponent fibers, wherein the multicomponent fibers include a polycarbonate region along an outer surface of the multicomponent fibers, the band having (i) a first side bonded to the section of first polycarbonate sheet extending outward along the data page, and (ii) a second side fastened within the booklet to create a hinge for the data page.

2. The security booklet of claim 1, wherein the polycarbonate region of the multicomponent fiber comprises a first taggant.

3. The security booklet of claim 2, wherein the first polycarbonate sheet of the data page comprises a second taggant, and the first taggant and the second taggant are different.

4. The security booklet of claim 2, wherein the first side of the band is marked with personal data.

5. The security booklet of claim 1, wherein the multicomponent fiber is a sheath and core construction and the sheath is the polycarbonate region.

6. The security booklet of claim 5, wherein the core of the fiber comprises a taggant.

7. The security booklet of claim 5, wherein the core of the multicomponent fiber is polyester.

8. The security booklet of claim 5, wherein the sheath of the multicomponent fiber comprises a first taggant.

9. The security booklet of claim 8, wherein the first polycarbonate sheet of the data page comprises a second taggant, and the first taggant and the second taggant are different.

10. The security booklet of claim 5, wherein the sheath of the multicomponent fiber and the section of the first polycarbonate sheet extending outward along the edge of the date page are bonded together at a temperature above the melt processing temperature of the sheath and the sheet, whereby the sheath and the polycarbonate sheet are fused together at an interface between the two.

11. The security booklet of claim 1, wherein the band is a woven textile fabric comprising sheath and core bicomponent sheath and core fibers and the sheath is the polycarbonate region, wherein the bicomponent fibers are in the warp of the fabric, the weft of the fabric or both the warp and the weft.

12. The security booklet of claim 1, wherein the first side of the band is less permeable to air than the second side of the band.

13. The security booklet of claim 1, wherein the data page further comprises a second polycarbonate sheet and a section of the second polycarbonate sheet extends outward along an edge of the data page, opposite the section of the first polycarbonate sheet and the first side of the band is positioned between the sections of first polycarbonate sheet and the second polycarbonate sheet extending outward along the data page.

14. A security booklet comprising:
(a) a data page having a first polymer sheet, wherein a section of the first polymer sheet extends outward along an edge of the data page;
(b) a band of textile fabric incorporating a plurality of multicomponent fibers, wherein the multicomponent fibers include a first polymer component and a second polymer component, whereby the second polymer component is exposed on the surface of the fibers; the band having (i) a first side bonded to the section of first polymer sheet extending outward along the data page, whereby the polymer sheet is bonded to the second component of the multicomponent fiber at an interface by fusing the polymer sheet and the second component at the interface; and (ii) a second side fastened within the booklet to create a hinge for the data page.

15. The security booklet of claim 14, wherein the multicomponent fiber has a sheath and core construction and the second component comprises the sheath.

16. The security booklet of claim 15, wherein the sheath incorporates a UV absorber and the core incorporates a fluorescent colorant.

17. The security booklet of claim 15, wherein the band is a woven textile fabric and the multicomponent fibers are continuous filament fibers oriented in the warp direction, or the weft direction or in both the warp and weft direction.

18. The security booklet of claim 15, wherein the sheath of the multicomponent fiber has a melting temperature within 25° C. of the melting temperature of the polymer sheet of the data page.

19. The security booklet of claim 14, wherein the first side of the band is less permeable to air than the second side of the band.

20. The security booklet of claim 14, wherein the first side of the band is stiffer than the second side of the band.

21. A security booklet comprising:
(a) a data page having a first polymer sheet, wherein a section of the first polymer sheet extends outward along an edge of the data page;
(b) a band of textile fabric incorporating 5% or greater by weight of multicomponent fibers, wherein the fibers comprise a polymer sheath and a polymer core, the band having (i) a first side bonded to the section of first polymer sheet extending outward along the data page, whereby the polymer sheet is bonded to sheath of the multicomponent fiber, and (ii) a second side fastened within the booklet to create a hinge for the data page.

22. The security booklet of claim 21, wherein the band is a woven textile fabric and the multicomponent fibers are continuous filament fibers oriented in the warp direction, or the weft direction or in both the warp and weft direction.

23. The security booklet of claim 21, wherein the core has a melting temperature of 50° C. or greater than the sheath.

24. The security booklet of claim 21, wherein the sheath incorporates a UV absorber and the core incorporates a fluorescent colorant.

25. The security booklet of claim 21, wherein the first side of the band is less permeable to air than the second side of the band.
